(19) United States
(12) Patent Application Publication
(10) Pub. No.: US 2017/0199518 A1
(43) Pub. Date: Jul. 13, 2017

(54) Method for manufacturing a product with integrated planning and direct holistic control

(71) Applicant: nextLAP GmbH, Munich (DE)

(72) Inventors: Thomas Stoeckel, Munich (DE); André Ziemke, Munich (DE)

(21) Appl. No.: 15/399,954

(22) Filed: Jan. 6, 2017

(30) Foreign Application Priority Data
Jan. 8, 2016 (DE) 10 2016 100 241.0
Mar. 3, 2016 (DE) 10 2016 103 771.0

(51) Int. Cl. G05B 19/418

(52) U.S. Cl. CPC G05B 19/41885; G05B 2219/40113; G05B 2219/33286

(57) ABSTRACT

In various embodiments a method of manufacturing a product is provided, the product being a functional unit composed of at least two parts, each of which is located at a separate location, the method comprising at least one logistics process, in which a part is transported from its location to a location of use, and at least one production process, in which the part is assembled with at least one further part at the location of use, wherein the method is planned and/or simulated in a holistic manner before and during its execution in a first electronic data processing program and/or is directly controlled in a holistic manner by a second electronic data processing program, wherein the direct control takes place with regard to a group of production factors, which includes employees and/or operating resources and/or material.

### CROSS-REFERENCE TO RELATED APPLICATIONS

This application claims priority to German Patent Application No. 10 2016 100 241.0, filed on Jan. 8, 2016 and German Patent Application No. 10 2016 103 771.0, filed on Mar. 3, 2016, both of which are incorporated herein by reference in their entireties.

### BACKGROUND OF THE INVENTION

The invention relates to a method for manufacturing a product, for example a motor vehicle, the method comprising integrated planning and a direct holistic control of the overall manufacturing process.

When it comes to industrial manufacturing or production of products, logistics and manufacturing processes are predominantly planned in divisions or areas separate from one another and are also operatively controlled in divisions different from one another.

The first are planned as part of logistics planning and the later are planned as part of manufacturing planning (production scheduling). They are also operatively controlled by different divisions, for example the first by operative logistics and the latter in corresponding manufacturing sectors or production areas.

Historically, this has resulted in the fact that the methods, processes and systems—IT-systems and industrial manufacturing equipment—are different from one another. The relevance of this fact becomes more clear when it is realized that in a modern automobile plant today more than 500 different IT-systems are required for the control of manufacturing/production and logistics.

An example of different methods used in production and logistics is the acquisition and evaluation of work. In production, this process takes place through time management methods by means of industrial engineering; in logistics this method is usually not employed. Another example is the different industrial manufacturing equipment and IT-systems for control of pick processes in production and logistics.

At the same time the demands on a closer process-based integration of production and logistics are increasing: in the future, an increasing amount of materials will be delivered just-in-time (JIT, i.e. synchronized with demand) or in the more developed form just-in-sequence (JIS, i.e. synchronized with order of use) in order to be able to minimize storage area despite the continuous increase in variant diversity. One of the goals of logistics is to provide each piece of material as JIT piece and/or JIS piece and thus without local warehousing. As a result, in the future, logistics will be work synchronously with the cycle or rhythm of production and will have to adapt to the latter. A further trend is the development of the delivered material from a single component to a more complex part module. The consequence thereof is that production activities and concomitantly added value (net product) are transferred from the production line to the logistics chain whereby logistics takes over the responsibility for the setup and flawlessness of entire modules.

Since today logistics and production processes are planned and operatively controlled in many different and only partly interconnected IT-systems, there is a lack of the overall picture of the manufacturing process. Hence, comprehensive, global optimizations which take into account all relevant processes are impossible.

### SUMMARY OF THE INVENTION

In one embodiment, a method for manufacturing a product, the product being a functional unit composed of at least two parts, each of which is located at a separate location, includes the steps of at least one logistics process, in which a part is transported from its location to a location of use, and at least one production process, in which the part is assembled with at least one further part at the location of use, where the method is planned and/or simulated in a holistic manner before and during its execution in a first electronic data processing program and/or is directly controlled in a holistic manner by a second electronic data processing program, wherein the direct control takes place with regard to a group of production factors, which includes employees and/or operating resources and/or material. In one embodiment, the first electronic data processing program and the second identical program are identical. In one embodiment, the group of production factors also includes data. In one embodiment, at least one instance in the first electronic data processing program and/or in the second electronic data processing program is allocated to each physical object which is involved in the method. In one embodiment, each physical object which is involved in the method is assigned an address which is preferably based on the internet protocol. In one embodiment, the first electronic data processing program and/or the second electronic data processing program include a suitable programming interface for each physical object involved in the method. In one embodiment, each physical object is associated with at least one instance via its address. In one embodiment, the holistic direct control of the method is executed by the second electronic data processing program on the basis of process information which is transmitted from the physical objects to the instances in real time.

In one embodiment, a computer program for manufacturing a product is configured to perform the method according to the various embodiments upon execution on a data processing device which is coupled to respective production factors. In one embodiment, a computer program product includes executable program code, where the program code, when executed by a data processing device coupled to respective production factors, executes the method according to the various embodiments. In one embodiment, the computer program which is provided in an executable manner is on a data processing device and is coupled with respective production factors.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 shows a task landscape which can be found nowadays in industrial plants in production and planning.

FIG. 2 shows a diagram in which a nowadays usual information technology implementation of a production management system which is usually used today is illustrated.

FIG. 3 shows a diagram in which an information technology implementation of a production management system according to the invention is shown.

FIG. 4 shows the embedding of an IT system which embodies the method according to the invention in a production landscape.

FIG. 5 shows a diagram illustrating how production is nowadays controlled and optimized.

FIG. 6 illustrates the operation of the production process platform according to the invention.

FIG. 7 shows an embodiment of the production process platform, which may be used for planning and possibly simulating and controlling an industrial overall production process.

FIG. 8 shows a basic process sequence in the planning tool according to the present invention.

FIG. 9 shows a diagram illustrating the mapping of real objects involved in the overall production process into a program level of the method according to the invention.

FIG. 10 shows a practical example of the operation of the method according to the invention.

FIG. 11 shows a pick-by-light rack and its control by the method according to the invention.

FIG. 12 shows a diagram in which a schematic representation and operating structure of the planning tool according to various exemplary embodiments is shown.

FIG. 13 shows an exemplary sequence scenario in the control of a supply chain and of the production process based on the pull principle according to the method of the invention.

FIG. 14 shows an exemplary sequence scenario in the control of a supply chain and of the production process based on the push principle according to the method of the invention.

FIG. 15 illustrates an exemplary process sequence in the production process platform.

### DETAILED DESCRIPTION OF THE INVENTION

It is to be understood that the figures and descriptions of the present invention have been simplified to illustrate elements that are relevant for a more clear comprehension of the present invention, while eliminating, for the purpose of clarity, many other elements found in systems and methods of manufacturing a product with integrated planning and direct holistic control. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

Referring now in detail to the drawings, in which like reference numerals indicate like parts or elements throughout the several views, in various embodiments, presented herein are systems and methods of manufacturing a product with integrated planning and direct holistic control.

The aim of the invention described herein is to co-ordinate the single processes from production of products and the processes from logistics in a better way with regard to one another and to make the overall or entire process (i.e. the overall manufacturing process) more efficient.

The solution of the task is based on a unification of methods and processes from production and logistics in a common planning tool to allow for holistic or integral planning, optimizing and simulating of processes.

An example for the unification or standardization of methods and processes is today's modelling of an assembly, which methodically takes place based on a sequence of stations, at which work is executed. The logistics process may be modelled in an analogous manner: logistic stations may then be sites for arrival of goods, order picking sites or transport routes. As a further example in this respect time management methods shall be mentioned which may be easily applied to logistics within an integrated planning tool.

Examples for the unification or standardization of processes are the process-based implementation of the application of time management methods (who, how, what, when) or the transfer of quality processes from production to logistics.

Examples for the unification or standardization of systems are pick by light systems, pick by voice systems and the like, which are used both in production and manufacturing and which nowadays are quite often different from one another.

Building on the common planning tool, a common operational process control system for production and logistics is used to control the manufacturing process in a holistic or integrated manner. The operational process control system is based on real time data from the entire process chain, i.e. it encompasses all production and logistics processes, from the supplier up to the material delivery at the location of need (e.g. location of use).

The planning tool and the process control system together embody the so called production process platform. The production process platform presents a digital overall view of all processes on the basis of which a holistic process optimization is enabled. These optimizations may be performed manually or in a (partly) automatic manner. Manual optimizations are may be executed more efficiently and more easily due to the complete transparency of the overall process. (Partly) automated optimizations, for the first time, may be applied to the overall process by application of artificial intelligence or deep learning methods (i.e. machine learning by means of algorithms which imitate human learning) on the basis of real time data.

The common (collective) and holistic planning of production and logistics processes in one planning tool reduces planning times by the factor of 2 to 4 and enables more efficient process sequences (also factor 2 to 4) since they optimally coordinated (e.g. synchronized) with respect to one another.

The operative process control system, based on real time data, enables a holistic control of all processes in order to achieve a global total optimum.

Optimizations in the planning tool and in the process control system, possibly based on real time data, allow, for example, for a very quick reaction to process deviations (e.g. quality problems, errors, failure of machines, congestion in the material supply) based on well-grounded decision options, possibly pre-simulated in respect of the event causing the deviation.

In summary, the single processes in the industrial manufacturing of products, including the logistics process, may be, in the context of the overall process, better coordinated with respect to one another and optimized in real time with regard to planning and control in order to achieve a global total optimum from the perspective of the overall process.

Preferably, the planning and operative control may be realized in only one tool, in which, moreover, logistics and production processes may be coordinated jointly. This provides a lot of advantages, whereby numerous problems may be solved. For example, it is no longer possible to use outdated planning statuses at the factory, which do not represent the actual operative process in manufacturing and/or logistics (e.g. due to a lack of communication between those fields). Moreover, based on a current state (operating state), a forward view may be performed (simulation of “what would happen if” scenarios). Further, by means of the unified or integrated planning, simulation and control tool, each individual point of the overall process may be controllably modified, without inconsistencies between processes being generated which are controlled separately and are executed far apart from one another but are still dependent on one another, which in the worst case may lead to downtime in production. The impacts of each individual modification of or intervention into the overall manufacturing process may be simulated with all possible consequences and examined with respect to their compatibility with the existing overall process beforehand in the planning tool. In this manner, the total optimum for the overall process may be calculated and controllably set in real time.

In various embodiments a method for manufacturing a product is provided, wherein the product is a functional unit composed of at least two parts or components, each of which is located at a separate location. The method includes at least one logistics process, in which a part is transported from its location to the location of use, and at least one production process, in which the part is assembled with at least one further part at the location of use. The method is planned and/or simulated before and during its execution in a holistic manner in a first electronic data processing program (hereinafter: first program) and/or is directly controlled in a holistic manner by a second electronic data processing program (hereinafter: second program), wherein the direct control takes place with regard to a group of production factors, which includes employees and/or operating resources and/or material.

By means of the overall production process considered within the scope of the invention, any functional units can be produced as products. These can be mechanically and electronically complex products such as motor vehicles, computers and mobile telephones or rather simpler products such as hairdryers and bicycles. The process is particularly suitable for products which are manufactured industrially in large quantities. However, all products which can be produced by means of the method have in common that within the scope of the production process they are assembled from at least two parts or components, wherein at least one of the two parts may also already be a composite product. Each one of the at least two parts, which are assembled for the production of the product, is located in a separate location. This means, in the first place, that each of the at least two parts has to be transported to a location of need by means of a logistics process. This may be a logistical transport of the part from outside the factory (production facility) to the premises of the factory, or a logistical transport of the part on the premises of the factory, for example from a warehouse to a location of need. The part is processed at the location of need, for example by being assembled with another part or by being deformed. The place of need may therefore be seen as a location of processing or assembly from the viewpoint of the one part. It is, of course, conceivable that each of the parts is processed individually beforehand in the course of manufacture, e.g. varnished, deformed, or modified by addition of further parts. At a certain stage in the manufacturing process, however, the considered part is assembled with at least one further part. As a specific example, a transmission is mentioned here, which is first supplied to a factory by a supplier and then transported to the location of need where it is installed in a corresponding vehicle.

According to the invention, the method is planned in a holistic or integrated manner before and during its execution in a first program, i.e. a correspondingly configured software program, and preferably also simulated. Within the first program the modeling of processes of logistics and production takes place in an integrative (unified) manner. The first program is configured such that the overall process can be mapped and/or preferably simulated for the purpose of planning. The first program is able to take account of all production factors and their influence on each other, regardless of whether they are to be allocated to logistics or production in the classical sense. In other words, by use of the first program, the overall process can be mapped or represented on an abstract planning level without fundamental distinctions being made whether a process or a method is to be allocated to the field of logistics or production. Using the first program, the entire process can be planned and/or simulated as a whole.

The simulation of the overall process can be uniformly integrated in the first program so that, for example, the production sequence according to the current configuration as planned until then may be simulated, for example on the basis of data to the extent as provided by a user to the first program (material flows, processing capacities, cycle times, etc.) or on the basis of real-time data from a real production. The simulation can also be a separate module.

However, in any case all the processes and methods that can be allocated to logistics and production in accordance with their nowadays common separation can be mapped or visualized on a program interface so that the overall process can be planned and/or simulated holistically or in an integrated manner, that is, without recourse to further software programs. The holistic planning and/or simulation of the overall process can be reflected in the architecture of the first program in such a way that all the parameters required to control the overall process (e.g. any actual values and target values of a process) which may be assigned to production factors, are assigned to planning objects. The first program thus has all relevant parameters which are necessary for the operation of the factory and for carrying out the overall process and it can take into consideration their influence among each other during planning and/or simulating. The planning and simulation functions of the first program may also cover all planning functions, including the support of their “temporal” subdivision into product planning, process planning and serial planning.

By means of the second program, the overall process actually taking place or being executed in a factory may be controlled on the basis of the results of the first program. The second program may be used to control all the processes involved in the overall process with respect to the production factors. For this purpose, the second program has interfaces, via which it is configured to communicate with any physical object that is involved in the overall process. Each physical object can receive data from the second program and/or transmit data to the second program. The physical objects can be sensors, robots, goods containers, conveyor belts, tools, components to be installed (which, for example, may include RFID (radio frequency identification) elements) or also people that electronic terminals are assigned to so that they can be integrated into the second program by means of data technology. The physical object referred to in this context may be manufacturing equipment. The physical object referred to in this context may be any physical object that play an active role in the manufacturing process.

From the point of view of the software architecture of the second program it is irrelevant whether, for example, a part required for production is delivered from outside the factory to the factory (classical logistics process) or whether a part is taken from a material container by a robot and mounted to a product to be manufactured (classical manufacturing process). In each case this is a chronological sequence of activities which are more precisely specified on the basis of parameters such as a (normalized) activity description, process duration, tolerance of the process time, used material, auxiliary and operating means, error cases etc. Both in the first program as well as in the second program, the entire logistics can be mapped or modelled, i.e. the entire supply chain from the point of origin of a part up to its location of need in the factory. Orders and order receipts can be taken into account, wherein employees from logistics may preferably use a different GUI (graphical user interface) of the first and/or the second program than the employees from production. In other words, the first and/or the second program may be used both in departments dealing with logistics as well as in departments dealing with production. Depending on the department, however, a different GUI may be used in which the focus is placed on characteristics of logistics (e.g., orders, order receipts, material flow) or on characteristics of production (e.g., workload of the manufacturing areas, wear of equipment). It is, of course, also possible to use a substantially identical GUI in both areas. In addition, in the first program as well as in the second program, all production areas can be mapped which have to be passed by the product-to-be itself and its submodules up to the final finished product.

The present method may also take virtual factories as a basis, i.e. spatially distributed production sites and/or manufacturing site networks for producing the product or the submodules required therefor. The spatially distributed production sites and/or production site networks can be treated as a coherent unit in the first and/or the second program, both visually and with respect to their programming. Accordingly, the term “factory”, as used herein, is not limited to spatially related manufacturing sites only, but may also refer to spatially distributed manufacturing sites participating in the overall manufacturing process.

Furthermore, the process described herein is applicable to all types of production, such as to workshop production, island production, flow production or serial production.

The special case of a virtual production line is also encompassed by the invention, in which the product is transported between individual production stations, with at least one working step being carried out at each station. The material required for the production of the product is delivered to the production stations as required. Virtual production lines may be understood as highly flexible and individual paths for each product, which are clearly different from today's “rigid” manufacturing lines (assembly lines). Each product to be manufactured may be transported along an individual production path to different production stations depending on the required modifications and degree of individualization.

The overall process is centrally controlled by the second program, which on the basis of the data provided to it by the production factors has a real-time image (presentation) of the overall process at all times and thus is aware of the prehistory of each physical object, its current state and its future. Seen in this way, the methods described herein may be understood as a further evolutionary step which provides an “operating system” that is suitable in terms of flexibility and efficiency.

By means of the method according to the invention, the integration of end users as well as business partners (e.g. suppliers) into the value-adding process, i.e. the overall process, from any incoming orders, via the planning and/or simulation of the overall process required for production through to the final production and subsequent delivery of the final product may take place. Through the fusion of the realm of logistics with the realm of production in the context of the method according to the invention, this entire value-adding process can be planned, simulated and controlled efficiently.

According to further exemplary embodiments of the method, the first electronic data processing program may be identical to the second electronic data processing program. In other words, the functional scope of the first program and the second program may be combined in a single program (hereinafter referred to as the program). By combining planning, simulation and control functions with regard to all production factors and the two fields of logistics and production in one tool, an overall process may be globally optimized across all degrees of freedom. Within the program, there is no separation between planning objects, that is to say, programmatic (program-based) images or representations of physical objects, in the planning tool and the simulation tool. Control objects may be understood as programmatic technical images or representations of physical objects in the control tool. This means, on the one hand, that the “status quo” of the overall process may be captures and adjusted at all times by means of a respective tool during ongoing operation in a factory. On the other hand, the impact of planned changes to the overall process may be simulated on the basis of the current configuration of the overall process. Here it is ensured that the simulation is performed on the basis of current parameters of the overall process and therefore no outdated process information is used. The program may be seen as a central control unit, which is in communication with all production factors used in the factory.

According to further exemplary embodiments of the method, the group of production factors also includes data. The second program is therefore not only configured to execute central control (coordination) of the classical production factors man (i.e. human work), machine and material, but also controls or coordinates the flow of data between itself and the production factors and between the production factors themselves. Because the overall process in a smart factory (“intelligent factory) is characterized by a high degree of autonomous communication between the product and the machine within the entire manufacturing process, the second program may be predominantly attributed a superordinately coordinating role in the example of a manufacturing scenario in a smart factory

According to further exemplary embodiments of the method, at least one instance may be allocated to each physical object which is involved in the method according to the invention in the first electronic data processing program and/or in the second electronic data processing program. The allocation of multiple instances may be required if a physical object is mapped or represented by multiple instances.

In this context, the instance may be a planning object in the first program, that is, a virtual representation of a production factor, which is specified by its characteristics and is used for the representation/mapping of the overall process in the first program. Likewise, the instance may be a control object in the second program, that is, a virtual representation of a production factor, which is specified by its characteristics and is used for the representation/mapping of the overall process in the second program. The planning object may merge with the control object if the range of functions of the first program and the range of functions of the second program are combined in one program.

According to further exemplary embodiments of the method, each physical object which is involved in the method for manufacturing a product may be assigned an address which is preferably based on the Internet protocol (IP). Thus, any physical object, for example every physical object from the group of classical production factors, may be reached by means of communication technology within the scope of the method described herein. Planning objects and control objects may be coupled via addresses, as mentioned above e.g. IP addresses, with the corresponding physical objects by means of communication technology. The data exchange primarily serves the transmission of process information (actual values), which are transmitted from the physical object to the at least one corresponding planning object, and for transferring data for the process control (target values) which is transferred from a planning object to the corresponding physical object. The communication required for this may be established by means of communication channels known today (RFID, Bluetooth, WLAN, IrDA). Due to the availability of real-time data from the overall process, i.e. from logistics and production, the target values may be also calculated on the basis of the overall process by means of the disclosed method. This means that control towards the optimum of the overall process is possible in real-time—in contrast to today's situation, where there is no holistic view and optimization of the whole value chain, but only parts/segments of the overall process are controlled and optimized.

According to further embodiments of the method, the first electronic data processing program and/or the second electronic data processing program may have a suitable programming interface for each physical object involved in the method for producing a product. As a result, the first program and/or the second program may be adapted to each factory environment and thus to various technical environments. A programming interface, if necessary, may be individually adapted to each physical object so that the communication between the first program and/or the second program may take place and a conversion of target values, actual values and other data between the electronic programs and the physical object works smoothly. The programming interfaces may literally function as translators, which translate between the individual languages of the physical objects and the linguistic world of the first and/or the second program. Thus, the first and/or second program not only have complete access to any physical object, i.e. may retrieve data from the physical object and also store data on it. By means of the central collection and management of the data flows, each physical object can communicate with another physical object by means of the first and/or the second program, that is exchange data with the other physical object, even if the one physical object has a different programming from the other physical object. The first program may access data from a physical object and transfer data to the physical object to define/represent the physical object as a planning object and to then configure the physical objects of a factory according to a found or optimized global configuration. The second program may access data from a physical object and transmit data to the physical object to control it as a control object and, for example as part of an expansion of the factory or a modified configuration (e.g., changed process flows), to configure in accordance with the new requirements. In this case, advantageously, the data from a planned configuration, which may also have been additionally checked by means of a simulation, may be directly used and transmitted to the corresponding physical objects. In other words, configurations and scenarios may be planned for the overall process and additionally optionally simulated. If the first program and the second program are embodied by one program, a simulated (and deemed suitable) configuration may be loaded onto the physical objects, in particular machines, by means of a corresponding command. Furthermore, the program can adjust the times for the updates or changes to the process modes of the corresponding physical objects so that a trouble-free migration from a first process configuration to a second process configuration may take place. For this purpose, the reconfiguration of physical objects may follow a piece of material or a just manufactured product in the factory like a bow wave, such that from the next piece of material or the next product to be manufactured action are taken according to the new/updated operating mode.

According to further exemplary embodiments of the method, each physical object may be associated with at least one instance via its address, for example, as already mentioned above, the corresponding IP address. The instance may either be the corresponding planning object or control object, that is, the virtual representation of the physical object in the software environment. Thus, any physical object which is to be controlled in the context of the method as described herein (for example, a bonding robot) or whose data are to be retrieved (for example, a motion sensor) may be unambiguously identified and controlled. A link between the virtual world of planning, simulation and control and the real world may be established via the address assigned to each physical object. At any time, a new setting for the physical object, for example from the planning, simulation or control level, i.e. from the first and/or second program, may be transferred onto that physical object in the factory.

According to further exemplary embodiments of the method, the holistic or integrated direct control of the method may be executed by the second electronic data processing program on the basis of process information which is transmitted from the physical objects to the instances in the electronic program in real time. The process information may be data of any kind which is transmitted from the physical objects independently to the second program or which the second program requests actively. By monitoring and controlling processes throughout the entire value chain, i.e. from logistics aiming at procurement of the necessary materials or raw materials to the manufacturing process to the finished product, on the basis of real-time data, an industrial manufacturing process may be optimally configured by means of the inventive method. Deviations from the set configuration may be instantaneously detected (i.e., in real-time) in each section of the value chain. The detected deviations may then be reacted to, for example, by determining their influence on the overall process, for example by simulation, and by subsequently adapting the overall process in such a way that it runs optimally while taking into account the deviation. Advantageously, when evaluating the influence on the overall process, all other parameters of the overall process are available, updated in real-time, such that the deviation may be identified very precisely and its influence on the overall process may be calculated/simulated very precisely. By means of the holistic or integrated treatment of logistics and production within the scope of the method as described herein, the overall process may then be optimized as a whole, taking account of the deviation. In this case, “dead angles” can be avoided, i.e. areas which are far away from the area in which an adaptation is to take place and in which the influence of the planned adaptation cannot be estimated and may lead to inconsistencies.

Overall, the method according to the invention is distinguished by a combined, planning and/or simulation and operational control of processes in logistics and production on the basis of a complete interconnection of the production factors, i.e. of man, machine and material. These processes may be preferably combined in an electronic data processing program in which the overall process is virtually replicated and may be controlled on the basis of real-time data from the overall process.

Further advantages, features and details of the invention will become apparent from the following description in which embodiments of the invention are described in detail with reference to the drawings. The features mentioned in the claims and in the description can be relevant to the invention individually or in any desired combination. Furthermore, various embodiments of the invention may be combined to form a further embodiment according to the invention.

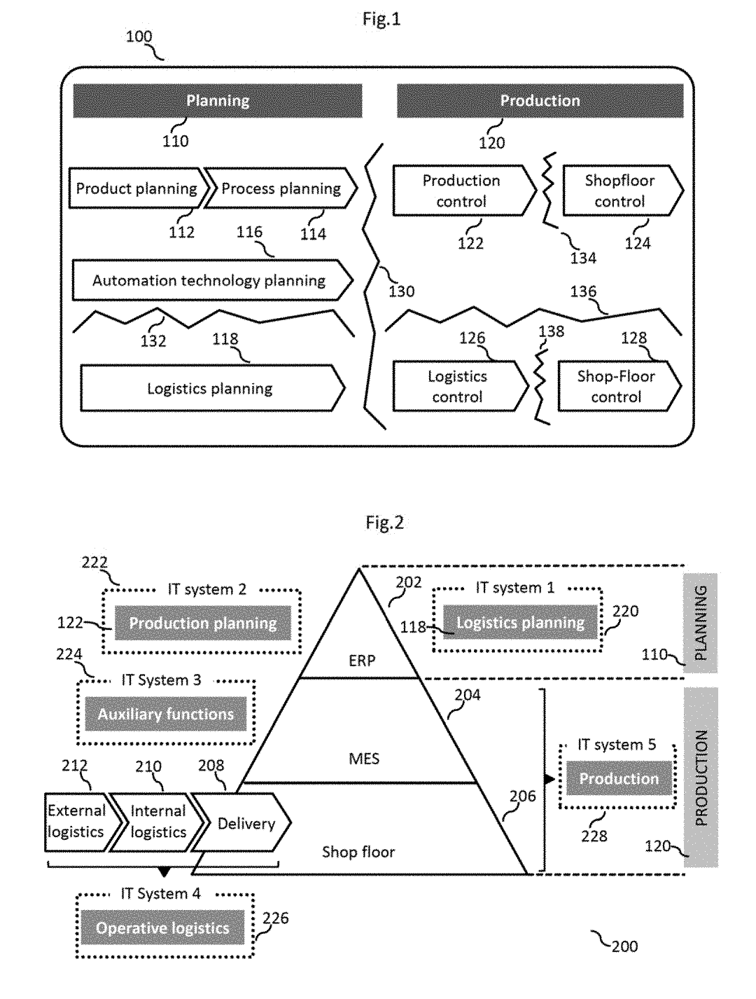

In FIG. 1, a task landscape is depicted, which is nowadays encountered in industrial plants in production and planning. The framing field 100 is intended to represent a manufacturing company. Within the scope of its economic activity such a company has to solve tasks of the two core areas: planning 110 and production 120. The strict separation of these two core areas leads to a first and most striking system or process break which is indicated in FIG. 1 by a first jagged line 130. Today's control of production 120 is based on specifications which were previously defined in planning 110. Not infrequently deviations to the planned state arise in the actual production control 120. Since there is no direct feedback from production 120 into planning 110, the state defined in planning 110 does not reflect the actual production 120. To put it in exaggerated terms, beginning with the day of production in a factory, the planned production state and the actually controlled production state are diverging. Control of production 120 is not executed directly out of planning 110, but from an implementation of the specifications determined in planning 110.

The classical tasks of planning 110 include product planning 112, process planning 114 that is based thereon, as well as logistics planning 118. The aim of the process planning 114 is to industrialize the required process sequences, whereupon the necessary technical production systems are determined in the planning of automation technology 116. Parallel to these tasks, but separate from one another, logistics planning 118 is performed. Here, a further process or system break can be identified, which is indicated by means of a second jagged line 132. Nowadays, logistics planning 118 is usually performed entirely separate from the product planning 112, the process planning 114, and the planning of automation technology 116, which are considered more valuable for economic added value. In particular, the logistics planning 118 is performed with other electronic data processing programs. In addition, it is usually executed in a subordinate manner and has to implement the specifications defined in process planning 114 and the planning of automation technology 116 and can only be optimized while remaining in compliance with these “boundary conditions”.

On the side of production 120 yet a further process or system break can be found—indicated by a third jagged line 134—between the production control 122 and the shop floor control 124. The production control 122 has the task of implementing the plans from the process planning 114 on the basis of the planning of the automation technology 116 in production. The shop floor control 124, on the other hand, represents the dynamic and flexible fine control of the production. Generally, the system break indicated by the third jagged line 134 between the production control 122 and the shop floor control 124 is present, because not all transport and production-specific specifications for the shop floor systems originate from the production control. In practice, this circumstance is noticeable from the fact that specific configurations are set locally on PCL units (PLC: programmable logic controller) or PCs in the shop floor.

A further system or process break, represented by a fourth jagged line 136, reflects the situation on the side of the planning 110: on the side of production control 120 also, the logistics control 126 is executed separately from the production control 122. That is, there is no central control unit, which controls production and logistics in an integrated manner and, for example, in the case of changes in the production control is able to adjust the logistics control in real-time. In addition, a fifth jagged line 138 represents yet a further process or system break which nowadays is to be found between the logistics control 126 and the shop floor control 128 concerning the logistics. The system break represented by the fifth jagged line 138 manifests itself in the same way as the system break 134 indicated by the third jagged line just described.

The highly segmented planning and production landscape illustrated in FIG. 1 in an industrial company is directly reflected in the way in which production is automated. FIG. 2 shows a simplified automation pyramid 200, which shows different planes according to the classification accepted today. The corresponding manufacturing process may take place in a factory or in a factory network. The top level of the automation pyramid 200 is the corporate level 202, which at the same time represents the level of planning 110. As already explained above, planning tasks are performed at this level; control of the production (for example, control of robots) is not carried out from this level. On the corporate level 202 enterprise resource planning (ERP) takes place which involves deploying and controlling resources such as capital, human resources, operating resources, materials, information and communication technology, such that the company's target will be reached. Two main tasks which are assigned to the company level 202 are the logistics planning 118 and the production planning 122. The logistics planning 118 and the production planning 122 are carried out separately from each other and not in an integrated process comprising both subfields. Based on this fact, a first IT system 220 is shown in FIG. 2 which is used for the logistics planning 118. Another, second IT system 222 is used to perform the production planning 122. These two IT systems operate independently of each other and there are no data objects which are kept synchronized in both IT systems.

Below the corporate level 202, the operation control level or production level 204 is located, which is primarily embodied by MESs (Manufacturing Execution System). The MES is characterized by direct connection to the plant engineering and automation technology in the factory, which enables their control in real-time. Therefore, as indicated in FIG. 2, this level, also referred to as the operation control level 204, is to be assigned to the field of actual production 120. At this level, tasks such as production data acquisition, material management and quality management are performed. These and further functions are summarized in FIG. 2 as auxiliary functions, wherein usually each of these range of tasks requires its own IT system. However, only one IT system is shown in FIG. 2, namely the third IT system 224, with which various auxiliary tasks are performed.

A further level which, together with the production level 204, embodies the actual production 120 is the shop floor level 206. This level, in which the entire plant engineering and automation technology is combined, is clearly also to be attributed to the actual production. From an entrepreneurial point of view, the actual value creation takes place at shop floor level 206 by need-based control from the superordinate level. The operational logistics being executed on the basis of structures that have been created by means of logistics planning 118 at corporate level 202 comprise the sub-fields of external logistics 212 (mainly procurement and distribution logistics), internal logistics 210 (movement of goods on the factory floor), and final delivery 208 of the materials to the location of need. In the scenario illustrated in FIG. 2, the operational logistics is handled by means of a fourth IT system 226. The entire production 120, comprising the production level 204 and the shop floor level 206, is controlled across levels by a further, fifth IT system 228.

Based on the schematic representation of the currently valid segmentation of production processes in the industry in FIG. 2, it can be seen that a plurality of IT systems is required for the planning and control of the overall production process. As already mentioned, this subdivision is a direct consequence of the classical way of thinking outlined in FIG. 1. It should be noted that the IT systems illustrated in FIG. 2 are rather representative of the respective fields and, depending on the complexity and extent of the factory, the IT landscape is formed by more than twenty individual systems. An overlapping or cross-field communication and synchronization of cross-program data objects between the different IT systems do not take place. Therefore, it is also very difficult to impossible to find a total optimum for the overall manufacturing process represented by the automation pyramid 200. The optimum within one IT system can be found, such as an optimum in terms of operational logistics. However, it cannot be ensured that the resulting advantage synergistically propagates through the other levels of the automation pyramid 200 and ultimately affects the overall production process in an optimal manner.

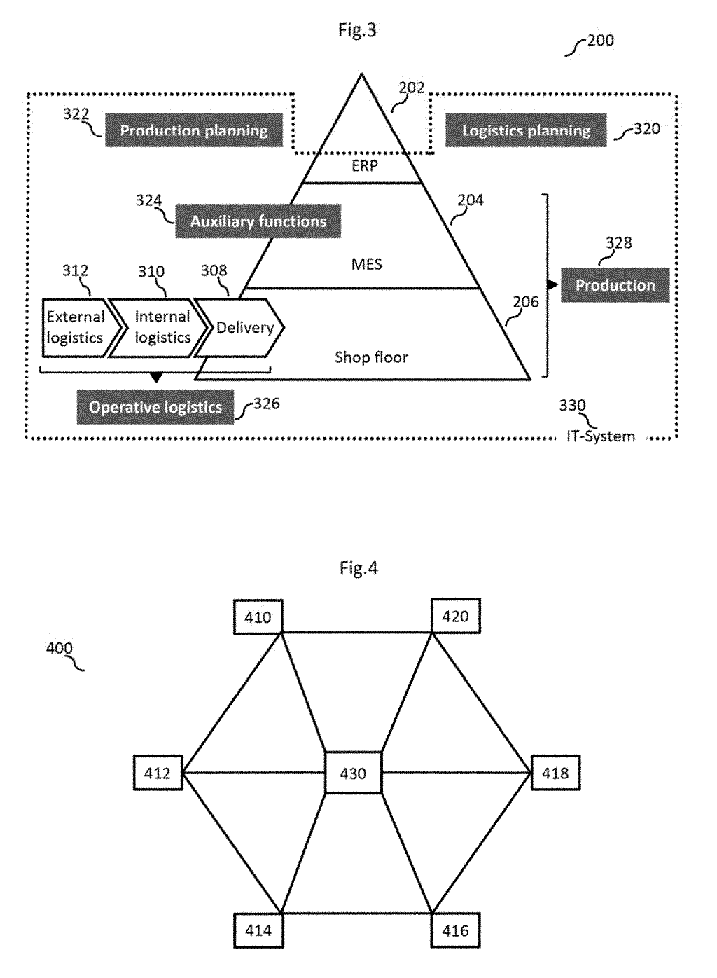

Starting from the presently common situation in industrial production as shown in FIGS. 1 and 2, in comparison thereto the approach according to the invention is illustrated in FIG. 3, in which the automation pyramid 200 from FIG. 2 is shown. The core tasks underlying the various IT systems from FIG. 2 are shown without their respective IT systems. The last two digits of the reference signs of the core tasks correspond to the reference signs of the associated IT systems in FIG. 2. Within the scope of the method according to the invention, only one IT system 330 is used, which allows for the planning and, if necessary, the simulation of the overall manufacturing process. In addition, the entire manufacturing process may be directly controlled by means of the IT system 330. In general, the IT system 330 may be a data engineering unit (i.e., a computer program executable on a computer) composed of the first program and the second program. Alternatively, functions of the first program and of the second program may be combined into the IT system 330, such that the IT system 330 is configured as a centralized and integrated IT system 330.

It is clear from FIG. 3 that the method according to the invention has considerable advantages compared with the previous approach, which is illustrated in FIGS. 1 and 2, which have already been discussed above. The automation pyramid 200 illustrated in FIG. 2 is based on an isolated solution (“island solution”) from the point of view of information technology. By contrast, according to the method according to the invention, the flow of information and goods may be planned and/or simulated using the first program and controlled by means of the second program (it is noted that in the context of this application that the term “control” encompasses both open loop control and closed loop control). The first and second programs, unless their functions are combined together into a single program, may be designed such that planning objects in the first program and the control objects in the second program are compatible with one another in terms of their data structure and are continuously synchronized with each other. This may ensure that the influence of each action by the user (e.g., parameter adjustment) is taken into account globally from the point of view of the overall manufacturing process. In this way, the overall manufacturing process may be optimized towards a global optimum. As illustrated in FIG. 3, the functions which are combined in the IT system 330 span all three levels of the automation pyramid 200, wherein the IT system 330 itself which embodies the method according to the invention may be assigned to the ERP level.

FIG. 4 shows a diagram 400 which illustrates the embedding of the IT system which is configured to carry out the method according to the invention into a production landscape. Objects 410-420 represent spatially separate factories, which together form a factory network. As already mentioned, in the context of this description, the term “factory” may at all times also relate to a group of factories. From the viewpoint of the method according to the invention, the planning, simulation and control of the overall manufacturing process is insensitive to a spatial distribution of factories which together form a group of factories as a functional unit. The IT system 430, which encompasses the first and the second program or is embodied by a single program which offers the functional scope of the first and second program, represents a control center from a functional point of view which monitors and controls the overall manufacturing process throughout the entire factory. The plant engineering and automation technology in each of the factories 410-420 is connected to the IT system 430 via corresponding interfaces. However, it is also envisaged that the individual factories 410-420 can exchange data among themselves. These data transfers are indicated by the lines between the individual factories 410-420. The data to be exchanged may, for example, be non-critical parameters, which are relevant only in a subset of the factories. In order to reduce the burden on the IT system 430, this data may be exchanged directly between the factories.

The diagram 400 shown in FIG. 4, however, can be also used to describe a different situation. Assuming that the diagram 400 shown in FIG. 4 relates to one factory, it illustrates the interplay between the IT system 430 and production factors, which are then represented by the objects 410-420. A data transfer may take place between all the production factors 410-420 and the IT system 420. However, direct communication between the individual production factors 410-420 is also conceivable, for example between a material part provided with an RFID transponder and a robot gripping arm. This type of communication is represented by the connections between the individual elements 410-420.

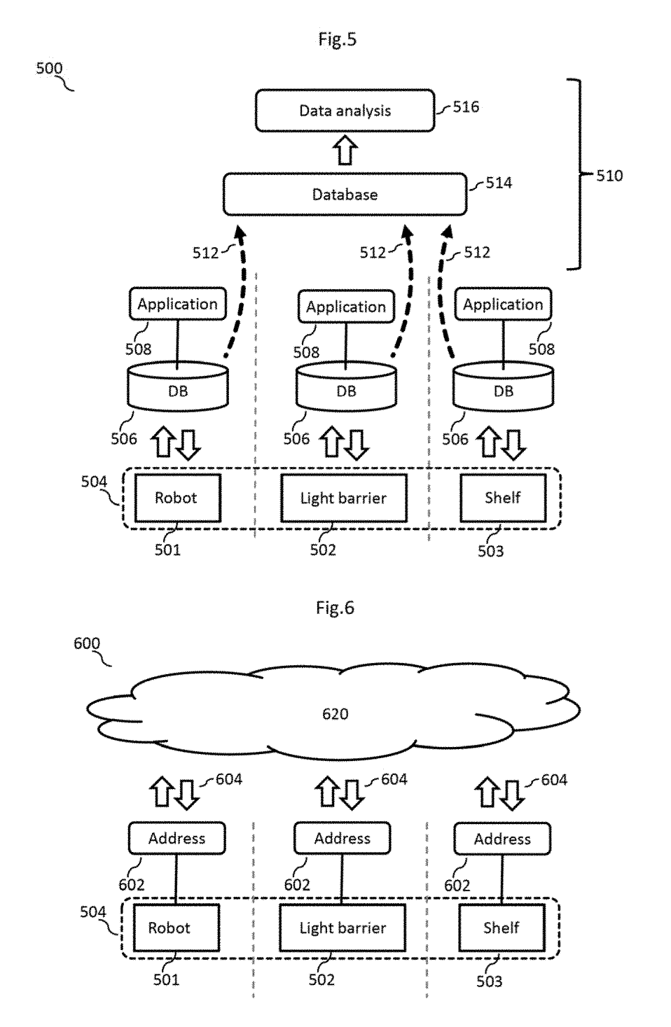

In order to further illustrate the difference between the present invention and the presently common approach in the planning and control of industrial manufacturing processes, a look at the current way in which production is controlled may be helpful. Diagram 500 in FIG. 5 shows how production is controlled and optimized nowadays. At the lowest level, there are three exemplary production factors 504: a robot 501, a light barrier 502, and a shelf 503 for accommodating various parts required for production. Each of the production factors 504, in particular each piece of automation technology (robot, shelf system, sensor), is usually supplied by another manufacturer. Consequently, each manufacturer provides their own automation application 508 for their piece of automation technology which may be used to control it. A database 506 is usually interposed between an application 508 and the associated production factor 504. During production, each system can be monitored and controlled separately and the corresponding work process can be optimized. In the standard process described so far, however, there is no comprehensive (overlapping) control and no cross-data interchange.

FIG. 5 also shows elements 510 which, so to speak, represent a first evolutionary stage of the standard process described so far. The data from the individual databases 506 of the respective production factors is collected in a central or superordinate database 514, for example in a cloud, the process being indicated in FIG. 5 by the dashed arrows 512. Since large and complex data sets are generated here, the term big data is usually used. On the basis of this centrally gathered data, respective technologies for data analysis 516 may be used, that is, processing and evaluation of these large amounts of data. In the context of the data analysis 516, production data may be centrally collected according to this first evolutionary stage, correlations may be analyzed and individual processes may be optimized individually and in isolation. However, the evaluation of the data from the central database 514 is limited to the establishment and verification of case scenarios only.

A further evolutionary stage, which can be explained by means of the diagram 500 shown in FIG. 5, consists in that the central data analysis 516 is not limited to verifying scenarios, but that the data analysis 516 may be may be analyzed from a processual point of view on the basis of the data stored in the superordinate database 514. This means that process mining technologies can be used, by means of which individual processes from production are reconstructed and analyzed on the basis of the data from the superordinate database 514. For example, individual steps from different systems can be comprehensively combined into one process (for example, all the steps required for installing seats in a passenger car) so that the process can be visualized and analyzed in its entirety. However, as indicated in FIG. 5, the arrows 512 representing the data stream extend and point only in one direction, i.e. from the individual device databases 506 to the superordinate database 514. This aspect reflects the fact that nowadays the flow of data from the sources to the programs, by means of which processes are visualized and analyzed in the course of the superordinate data analysis 516, is unidirectional. In other words, the process mining programs are a pure analysis instance, where isolated insights are obtained which may be incorporated into the control. There is, however, a direct influence from the level of such programs on production is not provided.

The method according to the invention is based on a completely different approach, which is illustrated in FIG. 6. The invention is based on a production process platform (a platform embodying the first and second program), in which the overall manufacturing process is planned in an integrated manner, optimized by means of various methods, such as deep learning (modern type of machine learning) and may be controlled in real-time. A major difference from the approaches presented in FIG. 5, which are widely used in industry today, is that the deployed production factors 504, in particular the machines used, possibly also tools as well as the work stations at which humans perform work, are connected with a central node, for example the IT system 330 (see FIG. 3), via a network. This central node thus has access to (essentially) all machines, tools and workers involved in the manufacturing process. In addition, as shown in diagram 600 in FIG. 6, a unique address, for example an IP address 602, may be assigned to each production factor. Via the address 604, a bidirectional data transfer 604 takes place between each networked object and the production process platform 620. That is, the production process platform 620 has access to the data of each of the objects 501, 502 and 503 and may also transfer data, e.g. instructions, to the objects 501, 502, and 503. As a result, a planned production state within the integrated production process platform 620 may be directly used for real-time control of the production out of the same platform 620. In addition, there is no separation between logistics and control within the scope of planning, as the case may be simulation, and control according to the invention. In the production process platform 620, the (partial) processes contributing to the overall production process may be mapped/represented from the classical viewpoint as integrated processes, which include logistics steps as well as production steps. For example, a process thread which relates to the installation of entertainment electronics into a passenger car may begin with the delivery of the entertainment electronics and further encompass its transport and temporary storage as well as its path to the installation location in a factory as well as the final installation steps. If the process plan is changed during ongoing production, for example by dividing the work steps from one work station to two work stations, this will be automatically visible in the process sequence and the delivery of parts which have been delivered to a certain work station in the factory is automatically updated accordingly, such that those parts are delivered to the corresponding one of the two newly designated work stations according to their installation location. Since planning and control is performed in an integrated manner in one production process platform 620, the control system is automatically updated upon a rescheduling of the operating state of a factory (possibly only after a consistency check of the planned change, for example by means of simulation). Conversely, a rescheduling is always based on the current operating status of the factory, since data reported in real-time from production is taken into account. The production process platform 620 according to the invention described herein may be seen as an implementation of the internet of things concept in production and logistics.

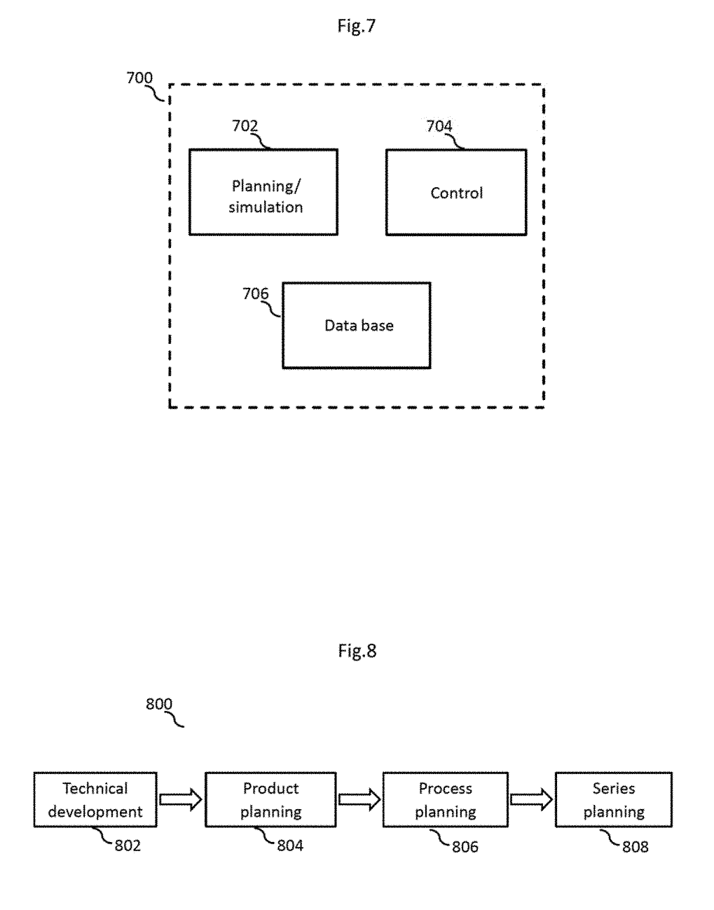

FIG. 7 shows the structure of an embodiment of an IT system 700 according to the invention (hereinafter also referred to as a production process platform), which is based on the method according to the invention. It may be used for planning and, if necessary, simulation and for controlling an industrial overall manufacturing process. The IT system 700 may include the first program 702 as a type of planning and possibly simulation editor for planning and possibly simulating a configuration of the production factors. The IT system 700 may also include the second program 704, which is set up as a control module for controlling the production factors in the planned production operation. The first program 702 and the second program 704 may be provided as independent coexistent modules. In this case, however, the planning objects in the first program 702 and the control objects in the second program 704 would be compatible with one another and synchronized with one another. Both programs may then have the same interfaces for information-technological communication with the production factors. In a preferred embodiment, the first program 702 and the second program 704 are submodules of a uniform IT system 700 such that a planning object from the realm of the first program 702 and a control object from the realm of the second program 704 form a uniform data object within the IT system 700. Irrespective of the exact data-technical architecture of the IT system 700, it may also have a database 706, in which data relevant to the overall manufacturing process is stored. The data may relate to, for example, information on materials (for example, raw materials or supply parts) or received orders. Information with regard to the materials may be determined, for example, from the bills of materials and the received orders may be retrieved from the ERP. Furthermore, data generated by the IT system 700 may be stored in the database 706, such as the layout plan of the factory or the process plan. On the basis of such data, the control of the overall manufacturing process may be executed. By integrating the planning function (possibly including simulation) and the production function in one comprehensive application, the existing process-technical and IT-technical break between planning and operational control as well as between production and logistics can be can be removed by means of the method according to the invention.

The task areas shown in FIG. 3, logistics planning 320, production planning 322, auxiliary functions 324 from the MES level, production control 328 and control of the operative logistics 326, which are nowadays processed by means of mutually independent IT systems (as shown in FIG. 2) may, according to a further embodiment of the invention, be all handled by means of standardized process modules, for example “apps”, which in their entirety form the IT system 700. In a preferred embodiment, the process modules may be embedded in an integrated overall solution or they may, according to the two task areas of planning and possibly simulation on the one hand and control on the other hand, be separated in two programs, the first program and the second program.

FIG. 8 shows a flow diagram 800, which illustrates a basic process sequence in the planning tool according to the present invention. The illustrated process sequence begins with the technical development 802 of a product, for example on the basis of a product requirements document. Technical development 802 is followed by product planning 804. In product planning 804, the sequence of resources, work processes and/or work steps is planned in order to produce the conceived product. Here, the planning with regard to added value and the process sequence is part-based. In this context, part-based means that the product planning is based on part types, e.g. “steering wheel”, partly also directly based on part numbers of the corresponding parts or modules. The product planning 804 is performed independent of the manufacturer, that is, without taking account of the factory layout. At this point it becomes clear that it is irrelevant for the method according to the invention whether ultimately the product is manufactured in a factory or in a group of factories. In the course of product planning 804, each planner involved in this phase works based on a stock of parts assigned to him. The validity of planned work steps can be verified using the bill of materials. After completion of product planning 804, a product plan is available.

The product planning 804 is followed by process planning 806. In process planning 806, the part-based process flows determined in the previous phase from the product plan are assigned to stations and work stations within the manufacturing plant or factory. More precisely, the physical layout of the factory is planned (colloquially a plant model), for example comprising one or more plants, segments, crafts, lines, line sections and stations.

Work stations may be planned according to capacity requirements per station. In addition, the necessary operating equipment is defined and assigned to work steps and/or test steps. Finally, the process sequence at the defined work stations is also determined. After completion of process planning 806, a process plan is available.

After process planning 806 has been performed and completed, the last step to follow is the series planning 808. Within the scope of series planning 808, activities of the product planning 804 and the process planning 806 are carried out. Here, however, the focus is on re-clocking, i.e. on a reassignment of work processes/work steps to stations and workplaces. Work stations, including all assigned work and/or test steps and resources, can be moved to other stations. Similarly, allocations of individual working steps and/or test steps can be moved to other stations or workplaces. Furthermore, the order of activities in the process sequence at a work station may be modified within the scope of series planning 808. The resources which have been determined and allocated to the operating and/or checking steps may be changed, for example added or deleted.

The method according to the invention is applicable to all types of production defined in the relevant literature up to now, for example to workshop production, island production, flow production or serial production. Workshop production may be understood as production by skilled personnel on similar machine systems which are arranged spatially and immovably in a factory, the conveying process being of a discontinuous nature. Island production may be understood as a production of products in families of parts, wherein each part of a family of parts has a similar production process and wherein each family of parts is processed by a number of work units. The operating equipment and work staff of a work unit are spatially grouped and thus form the production islands. Flow production may be understood to be a production in which the operating equipment and work stations involved are arranged according to the production process, i.e. according to the order of the individual work steps. In series production, the production takes place in batches, wherein the workpiece to be produced is transported batchwise from one workplace to the next; there is no rigid coupling between work stations. In accordance with the VDI (Verein Deutscher Ingenieure, English: Association of German Engineers) Guideline 2815, a serial production of materials and products may be understood as staged production of material and products in spatially related and stationary work stations of a subarea, arranged according to the production sequence, while the type division of parts is predetermined, with continuous, fixed timing and using different work staff, which do not change during the order execution. In particular, by means of the integrated handling of logistics and production processes, all of these different types of production are accessible to the method according to various embodiments.

Likewise, by means of the method according to the invention, production modes of different degrees of mechanization (manual, mechanized or automated) may be handled, as well as types of production which from the viewpoint of their sales market depend on a make-to-stock production/market production or on customer order production. Finally, the method according to the invention is applicable to production types of different repetition types, i.e. mass production, variant production, serial production or individual manufacturing.

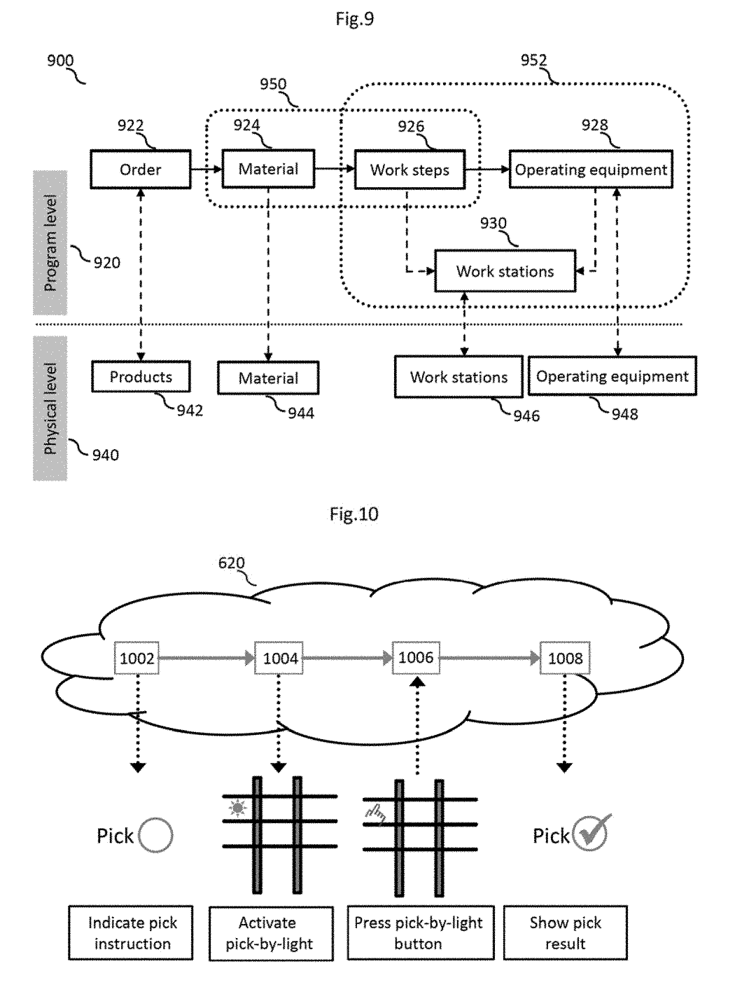

The basic planning and control of a complete manufacturing process according to the method of the invention is explained below with reference to the diagram 900 shown in FIG. 9. The dotted dividing line in the diagram 900 divides the diagram 900 into two halves. In the upper half, the program level 920 is located, such as the program level of the production process platform, which is configured to plan and/or control the overall manufacturing process according to the method of the invention. In the lower half, on the other hand, the physical layer 940 is represented, i.e. the factory or group of factories together with all the production factors provided there.

In the program layer 920, program and control objects 922-930 are shown. On the basis of an order 922, the material 924 required for the production of the ordered product may be planned by means of the planning tool. The required material 924 may be assigned to individual working steps 926. This process is included in the classical product planning 950. As explained in the preceding FIG. 8, the work steps 926 may then be assigned to work stations 930 and operating equipment 928 during process planning 952, wherein operating means 928 may also be directly assigned to work stations 930. All these processes may be planned and possibly simulated using the first program. A correspondingly configured overall manufacturing process in a factory may then be controlled by means of the second program.

There is a data link between the planning and control objects 922-930 of the program level 920 and the corresponding physical objects. Thus, all objects of the physical level 940 may be communicatively coupled to corresponding program objects of the IT system. In other words, each planning and/or control object 922-930 may be linked to a corresponding physical object by means of a data link. These communicative connections are indicated by dashed arrows in the diagram 900 in FIG. 9. The allocation between the program level 920 and the physical level 940 may be mathematically seen as a surjective mapping since it may be that one and the same physical object is allocated to several program objects. For this purpose, a physical object may be assigned an IP address, for example, via which it is uniquely identified. Furthermore, RFID transponders and RFID readers may be used, for example, to identify workpieces or product parts and to track them within the overall manufacturing process. In FIG. 9, the program object modeling or representing the order 922 is thus linked with products 942 in the factory, for example with semi-finished products or with workpieces still to be installed. These may, for example, be provided with RFID transponders and thus be identifiable in the overall production process. Furthermore, the program objects which represent materials required for production may be linked to the corresponding materials in the factory provided with RFID transponders. Work stations 946 and operating equipment 948 are also linked to the corresponding program objects from program level 920, for example via IP addresses. Workers may be communicatively accessible or identifiable via work stations 946. However, in further exemplary embodiments, each worker may have an electronic terminal, via which he can receive information from program level 920 and also upload information to it. The terminal may, for example, be a touch-sensitive display or an AR spectacle (AR: augmented reality) and may also have a microphone and a loudspeaker so that the communication with the worker may also take place in a speech-guided manner. In such an exemplary embodiment, at least one program object may then be assigned to each worker in the program plane 920.

Altogether, the diagram 900 shown in FIG. 9 illustrates that by means of a coupling between program objects 922-930 (i.e. planning objects or control objects) and physical objects 942-948, holistic or complete control of the physical objects and thus of the overall manufacturing process is made possible within the scope of the method according to the invention.

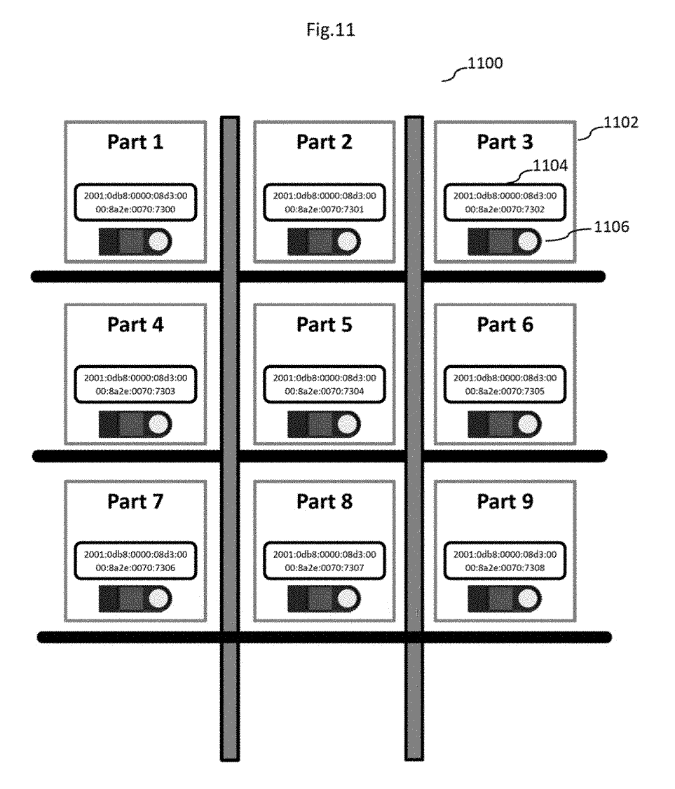

A practical example of the operating mode of the method according to the invention is illustrated in FIG. 10. A control of a mounting (assembly) work station, which has a pick-by-light shelf (rack), will be explained with reference to the figure. The control is performed from the production process platform 620, which is symbolized by a cloud. The process to be explained was planned in the production process platform 620 and corresponding instructions have been passed on to the affected production factors. In the present case, a pick-by-light shelf has seen configured accordingly.

The control process begins with a first step 1002, in which a pick instruction is indicated to a worker at the corresponding work station, for example, on an electronic display. In a further step 1004, the pick-by-light shelf is controlled and the designated compartment from which the worker is to pick up a part is marked, for example by means of a luminous display. In the subsequent step 1006, the input of the worker is awaited which confirms the extraction of the part by actuating the corresponding key, for example. Instead of the manual key actuation, a scanning device, for example, may be used, mounted on the pick-by-light shelf, where the worker scans the extracted part (optically, by barcode, or electronically via RFID transponder). After a successful detection of the withdrawal of the correct part (i.e. as designated), the pick result may be shown to the worker on the electronic display in a further step 1008.

Based on the scenario just described, the flexibility and performance of the method according to the invention shall be emphasized in the following. Supposing the worker at the assembly work station desires a reorganization of the pick-by-light shelf to improve working efficiency, such as to have to bend less frequently to lift heavy parts. By means of the production process platform 620, he himself may relocate the storage space of the heavy sort of parts into an upper level of the shelf and exchange it against the storage space of a lighter sort of parts. After the rescheduling has been completed, this change may be taken over into the overall controlling scheme, for example by actuating a button in the production process platform 620. Since there is no separation between logistics and production within the production process platform 620, the logistics planning is immediately adapted such that the heavy sort of parts will now be placed in the upper shelf compartment and the light sort of parts is placed in the lower shelf compartment.

The integrated planning and control of logistics and production enables further, up to now unknown possibilities. Thus, for example, a shelf which has a limited number of storage compartments may be virtually stocked with a number of sorts of parts which is larger than the number of compartments. This is not possible today. For example, certain parts which are rarely used for installation at a work station may be combined to be placed in one compartment according to the order in which they will be used. This is possible within the scope of the method disclosed herein since the pick instructions over the next assembly cycles are known or may be calculated. Based on this knowledge, the interim storage of the factory may be controlled in such a way that the rarely used parts are placed in a box in the predicted order of use and subsequently only use up only one compartment the shelf.

The two exemplary scenarios show that by combining planning and control functions, which moreover encompass logistics and production, the method according to the invention differs significantly from the classical planning and control concepts, used separately today.

In order to enable planning and control of the complete overall production process, the material storage at the respective work stations may be digitally integrated into the main system according to the method according to the invention. In FIG. 11 an exemplary pick-by-light self or rack 1100 is sketched, which comprises nine compartments 1102 (only the right upper compartment is exemplarily provided with reference numbers). Each of the compartments 1102 may have a storage container holding parts (components) used for assembly at the corresponding work station. As further illustrated in FIG. 11, each compartment 1102 of the shelf 1100 is assigned its own address 1104, for example an IP address. Each compartment 1102 of the shelf also has a pick interface 1106 which may be addressed by the production process platform via the address 1104 the compartment 1102. The pick interface 1106 may be a device which may provide a worker with signals and information (e.g., acoustic or optical) and may also receive input from the worker. For this purpose, the pick interface 1106 may include output means (e.g., an LED display or a loudspeaker) and input means (e.g., at least one key or a touch-sensitive area). In step 1004 in FIG. 10, for example, an LED display on the pick interface 1106 of the shelf compartment 1102 may be switched on and signal to the worker that he is to take out a part from the indicated shelf compartment to use it for assembly. In step 1006 in FIG. 10, the worker may then confirm the successful withdrawal of the part by pressing a key.

By means of such an electronic integration of the shelf 1100 as an interface between classical logistics and classical production into the production process platform according to the invention the withdrawal of parts may be controlled monitored in real time. This means that the stock in the shelf is known at all times and that parts, which will be employed in the foreseeable future, may be refilled on the basis of a pre-calculation of future products. The view shown in FIG. 11 illustrates the front side of the pick-by-light shelf 1100. The compartments 1102 on the back side of the shelf 1100, however, may be also equipped with electronic means which indicate which compartments are to be replenished when the shelf 1100 is being restocked 1100. At this point it is especially clear that within the production process platform logistics and production seamlessly transition into one another. A change in logistics is automatically taken into account in production and vice versa. As already mentioned, in the case of parts which are rarely used (but also in general), the logistical aspect of the work of a worker, namely the withdrawal of the correct part from the pick-by-light shelf 1100 and the transferal of this part directly to the location of assembly, may be transferred to logistics. At least one compartment of a pick-by-light shelf could be equipped with various parts of the same type (for example with differently colored decorative strips) in the order of their use. For this purpose, however, logistics must have precise knowledge of the production plan or the replenishing of the shelf with parts, a classical logistical task, has to be controlled according to the production plan. Such a procedure is now possible with the method as disclosed herein, since logistics and production may be planned and controlled uniformly.

For the sake of completeness, it should be mentioned that conventional shelf systems without the pick interfaces 1106 shown in FIG. 11 can be retrofitted with such devices. For this purpose, the pick interfaces 1106, which may be formed as palm sized devices, may be attached to the frames of a shelf, for example above the shelf compartments, and connected to a control device which can also be attached to the shelf. Such retrofitting requires little time such that it may be performed, for example, during a break in which a production line stands still in a factory. In the meantime, until the shelf is put into operation, which has been retrofitted to a Pick-by-light 1100, production can continue and the shelf can be used as a standard shelf.

When using the method presented here, the sorting task of logistics, i.e. the filling of a shelf compartment with the correct parts, i.e. the parts to be placed in a particular shelf compartment, may also be carried out by the production process platform. That is, the parts may be deposited into any empty shelf compartment 1102. By way of bar codes or RFID tags, for example, the shelf 1100 may autonomously determine which parts are located where and may convey corresponding information to the production process platform. The production process platform may then instruct the workers using the pick interfaces such that the correct parts are withdrawn from the shelf 1100 during assembly.

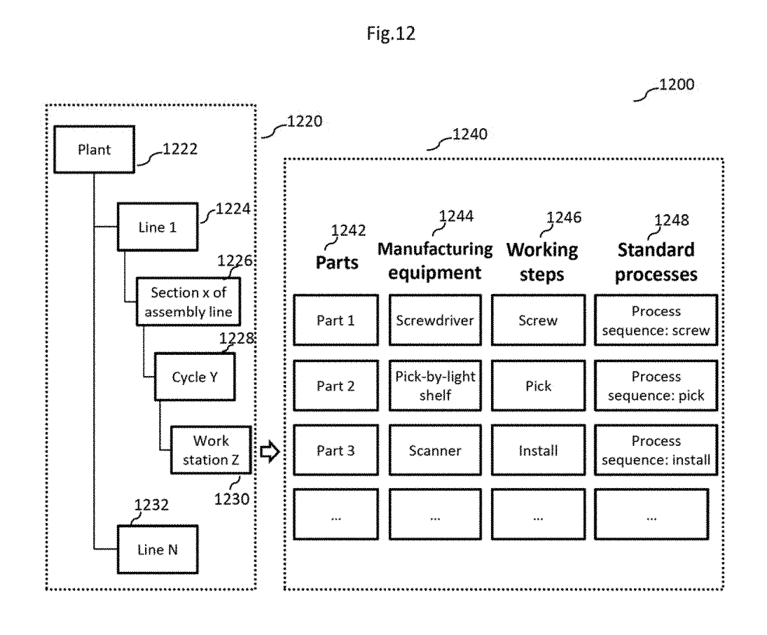

FIG. 12 shows a schematic representation and operating structure of the planning tool according to a possible exemplary embodiment. It should be noted that the illustrated structure corresponds only to one of many possible types of preparation and presentation of information about the overall production process. Of course, the scope of the information shown in FIG. 12 is also substantially reduced for the sake of simplified representation and is mainly intended to convey the function principle of the planning tool in a qualitative manner.

According to one embodiment, the layout plan of the factory may be represented by means of a classical tree structure 1220. The diagram 1200 shows a state where a specific work station is selected in a plant. In detail, it can be seen from the example shown that the considered plant 1222 has N production lines, of which only the first production line 1224 and the N-th production line 1232 are represented in diagram 1200 of FIG. 12. A particular x-th assembly line section 1226 is selected from the first production line 1224 and cycle Y (reference numeral 1228) is selected in this x-th section of the assembly line 1226. Finally, the z-th work station 1230 is selected. In the example shown, the planning tool is used in the context of flow production. For other types of production instead of the x-th line section 1226, an x-th manufacturing island could be selected, for example. The illustrated tree structure 1220 may be adapted to any type of production. With the exemplary tree structure 1220 shown, the factory layout may be displayed in a structured manner, regardless of the underlying production type, and thus each work station may be analyzed. However, the exemplary tree structure shown for displaying the factory layout may be structured according to other key parameters or it may also include further parameters. In addition, the sequence for the subgroups, as shown in FIG. 12, does not necessarily have to be chosen. In other words, the sequence of the respective subgroups may be adapted as desired, depending on what is advantageous for the control/usage at a particular moment. For example, the production lines 1224 or production islands of a plant may first be ordered according to cycles 1228 instead of according to assembly line sections 1226.

After selecting a work station or a workplace 1230, the work processes taking place at this work station may be displayed. This can be done, for example, by means of the exemplary object field 1240 as shown. Therein, the parts 1242 used at the selected work station 1230 as location of need are listed. In general, program objects may be created and parameterized for all IP-compatible, physical production factors involved in the overall production process. As illustrated, a manufacturing equipment (operating equipment) 1244 and a working process 1246, for example, may be assigned to each of the parts 1242. In addition, the standard process 1248 associated with the working process 1246 may be specified. It goes without saying that the order in which the parameters 1242-1248 are indicated may be adapted as required. From the embodiment as shown in FIG. 12 it may be inferred that at the x-th work station 1230 which is considered the third part (third element from the top in the column of the parts 1242) is used in a installing process as standard process, wherein it may be verified whether the correct part is being installed on the product to be produced by means of scanner as manufacturing equipment.

The key point is that the exemplary object field 1240 contains target values and actual values, wherein the latter may be retrieved in real time by the first program and/or the second program. The manufacturing resource pick-by-light shelf (second element from the top in the second manufacturing equipment column 1244) associated with part 2 in the parts column 1242 may be a program object which is communicatively coupled via an IP address to the corresponding actual pick-by-light shelf in the factory. All parameters defining the planning object and/or control object pick-by-light shelf may be transmitted and applied to the physical object pick-by-light shelf in real time. The planning tool may apply a collision check to all entries made and warn, for example, of inputs which are not compatible with the current configuration of the overall manufacturing process. For example, adding additional working processes at a work station may lead to the use of a manufacturing equipment for a longer period of time, such that it is not available for another working process and the other working process has to be postponed until the manufacturing equipment becomes available. This in turn may lead to delays at the other work station and overall delays in the corresponding section of the assembly line. This in turn may adversely influence the internal logistics chain. Since the control tool, which is configured to control the method according to the invention, has both the process plan for production processes as well as for logistics processes, a respective warning may be issued. This is only possible, since the production planning and the logistics planning are jointly managed on one platform in the planning tool. Therefore, both logistics processes and production processes may be grouped for one work station. The parameters which define the logistics processes and production processes may influence one another and this influence may be determined by the method according to the invention. A planned scenario may also be simulated in the planning tool at any time to ensure that i) there are no inconsistencies in the overall manufacturing plan and ii) optimization possibilities are identified and exploited to shift the overall manufacturing process towards a global optimum. By means of the communicative coupling between the production factors and their corresponding program objects in the IT system, a planned and, if desired, simulation-optimized configuration may be transferred (expressed colloquially: uploaded) directly to the plant engineering and automation technology in the factory.

The corresponding control tool according to the invention may have a setup similar to the planning tool. Through the coupling between the control objects and the means of production in the factory, the control is always carried out on the basis of up-to-date values, for example provided in real-time, from the overall manufacturing process. For example, the control tool according to the invention may autonomously determine the actual values of the production times and process times from the data retrieved by it and, by comparison with the target values, it may determine gradual processes of change, for example fatigue phenomena of the employees or wear phenomena at the technical systems. Processes in production and/or logistics may be selected on a case-by-case basis, i.e. depending on the upstream processes on which they are directly dependent. For example, if production times and process times increase at a particular workplace, the control program may determine that a delivery drone does not have to deliver the necessary material at the workplace for the moment. During this idle time, the drone can be maintained, for example. The distinctive characteristic of the method disclosed herein is the close interlocking between the planning tool and the control tool, in a particularly preferred embodiment even their integration in a single program, which allows for a smooth transition between control and planning of both logistics processes and control processes. That is, based on any current operating situation, a planning scenario may be generated, for example, when the overall production process is to be extended by working steps or technical devices, or when it is to be checked whether the production is carried out close enough to the global optimum. In addition, “what if” scenarios may be simulated and optimal target values may be extracted therefrom which may then be directly transferred and applied to the respective production factors. The above-mentioned tasks have such a high complexity, in particular in the manufacturing of complex modern consumer goods such as vehicles or entertainment electronics, that they require the use of electronic data processing systems (computers).

The difference between classical MES systems and the IT system configured to carry out the method according to the invention should be clear from the preceding detailed description with reference to the figures. While classic MES systems nowadays provide a network of the entire production, including shop floor, for the purpose of control, but excluding logistics, the method according to the present invention is based on a network of the entire manufacturing, including shop floor and also logistics. Moreover, within the scope of the method according to the invention, a comprehensive planning of production and logistics is performed, which is not the case with classical systems, as explained with reference to FIG. 2, since the planning tasks for the two fields (i.e. logistics and manufacturing) are solved separately.

Within the scope of the present description, the term station or work station may relate to the combination of machine, personnel and tool (equipment) into a functional unit. The term workplace may be understood as a working area of a worker at a station, wherein one station may have several workplaces. The term cycle may be understood as a time interval in which the product to be produced is moved from station to station. The term clocking may be used to express the allocation of working steps or working processes to stations. The working process may be understood as a summarization of working steps, wherein this term is often used as a synonym for the term working step. A working step may be understood as time-bound activity carried out by a person or a machine. The term production time may be understood as the time required for a person to carry out a value adding step in the product to be manufactured. The term process time, on the other hand, may be understood as the time required for a person to perform a non-value-adding step (for example, walking, waiting). This may, however, also mean the time required for a machine to carry out a working step.

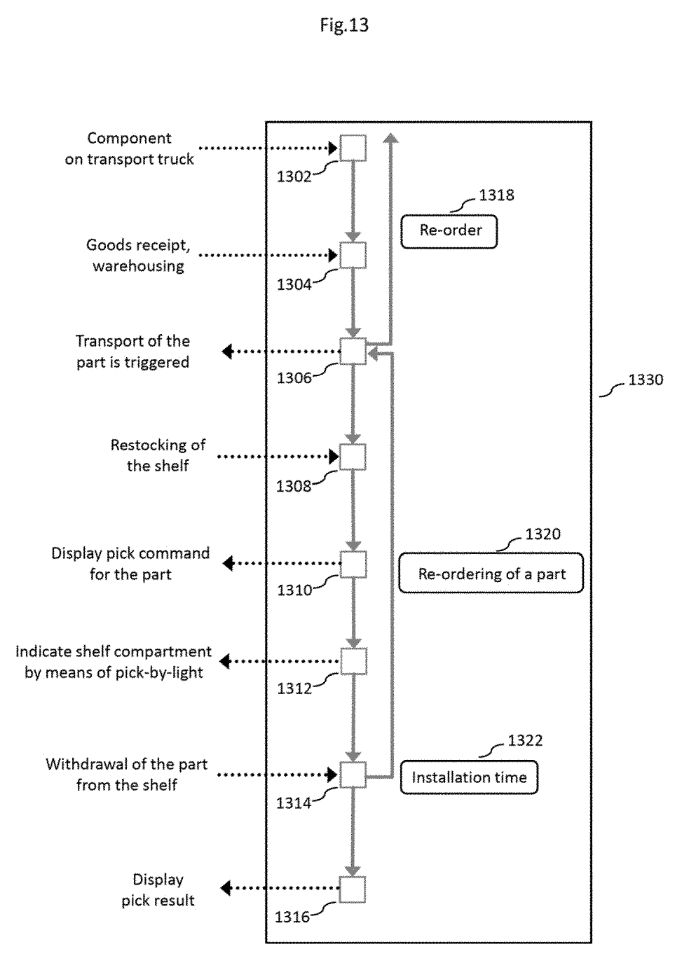

FIG. 13 illustrates the control of the supply chain and the production process of a component, for example a switch module steering column according to the method according to the invention. The illustrated process chain, which comprises steps 1302-1320 runs in the production process platform 1330 according to the invention. The control process shown is based on the pull principle, i.e. on a demand-oriented control of the processes. This means that used material triggers the logistical restocking process (for example, via Kanban). The control here is based, so to speak, on the material usage of the past. In FIG. 13, in addition to the process sequence within the production process platform 1330, events which belong to the respective steps are noted on the left-hand side. The arrows indicate whether the flow of information takes place from the events to the production process platform 1330 or vice versa.

The description begins with the loading of a component onto a transport truck at step 1302. The information about this state is obtained, for example, by scanning processes and/or from a GPS localization of the transport truck. The production process platform 1330 may also have access to data from the contracted logistics contractor and/or experience values for travel durations of the transport trucks. From this, delivery times for the goods at a factory may be determined, possibly also corrected on the basis of current traffic information. The delivered goods are registered at the factory at the goods receipt and may be stored. These processes may be mapped by the second step 1304 in the production process platform 1330, wherein information about the quantity, arrival time and storage location may be recorded, for example, by scanning processes. In a further step 1306, the transport of parts from the warehouse to a work station in the factory may take place. This process may, on the one hand, trigger an automatic re-order 1318 at the supplier, if, for example, the stock falls below a set value due to withdrawal from the warehouse. On the other hand, the transport of a part from the warehouse to a work station may be triggered by the withdrawl of the part from a shelf at a work station in the factory, for example when the number of these parts in the shelf drops below a set value. With anticipation of the further steps, a request 1320 of the part from the internal warehouse may thus be triggered by a consumption of the part at the associated work station. Upon initiation of transport of the part in step 1306 from an internal warehouse to the work station, the part is placed in the shelf at the work station after the transport has been carried out in the following step 1308. The information about a completed restocking of the shelf with new parts may be generated by means of scanning processes and transmitted to the production process platform 1330. For this purpose, a container, in which the newly delivered parts are contained, may have a barcode or an RFID transponder. Alternatively, electronic displays including acknowledgment buttons may also be mounted on the back of a shelf, which is restocked by the storage personnel, as described in FIG. 11. Regardless of how the restocking of the shelf is determined, the critical point is that the production process platform 1330 always has real-time data regarding the sub-processes shown in FIG. 13 and the entire process chain is controlled on this basis rather than on the basis of values from a “further” past.

The further steps are similar to those of FIG. 10. That is, in step 1310, the worker is informed by means of a display at the workplace that he is to withdraw the part from the shelf. In the subsequent step 1312, the pick interface is activated by the production process platform 1330 at the appropriate shelf compartment of the pick-by-light shelf. Thereupon, in the normal course of the process, the withdrawal of the part from the shelf takes place in step 1314, wherein the worker may confirm the performed withdrawal, for example, by actuating a button on the pick interface. As already mentioned above, the withdrawal of the part may automatically trigger an internal re-ordering 1320 if the number of parts remaining in the shelf falls below a predetermined set value. The withdrawal of the part from the shelf and the confirmation of the withdrawal by the worker may be equated with the installation time point 1322 of the part by the production process platform 1330. In the last step 1316, the pick result may be shown to the worker for confirmation by means of a display at the work station.

The diagram shown in FIG. 13 shows that the internal re-ordering 1320 of the consumed/used part is triggered by its withdrawal or its installation time. By means of the production process platform 1330, as described, steps 1302-1316 may be planned, possibly simulated, and also controlled, in the context of the overall process, with no separation between logistics and production. From the exemplary scenario it may be seen that that an event in production—the installation of a part—may automatically trigger a logistics process. Through the complete interconnection of the production factors (for example, manufacturing equipment involved in the depicted process), the current operating state of the factory is always represented in the production process platform 1330.

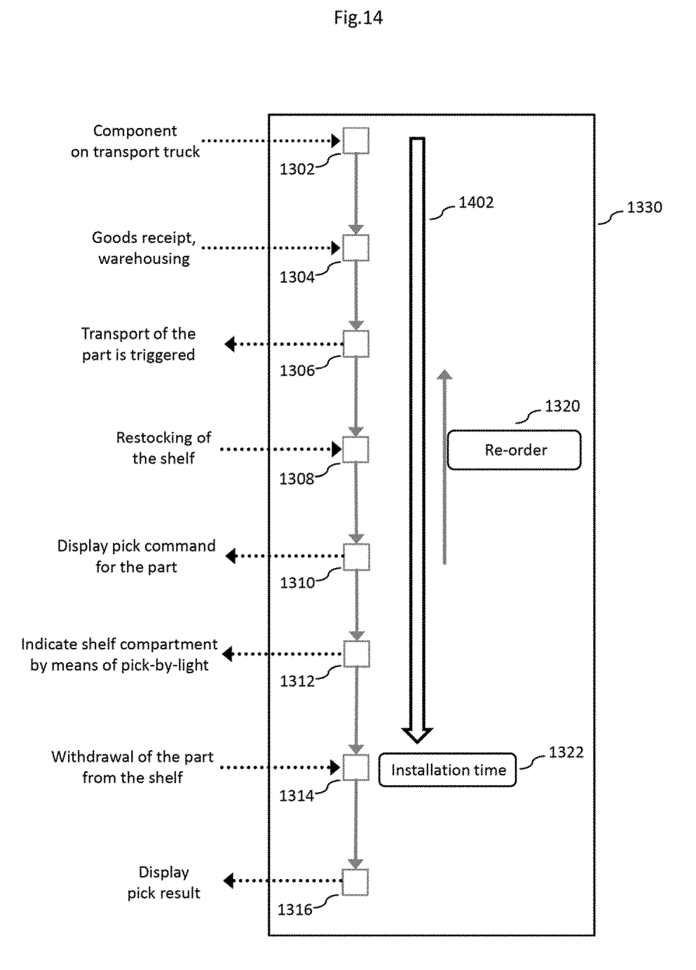

By means of the method according to the invention it is also possible to calculate at any time taking into account the current operating state which part is required at which time at which work station. On the basis of such a preview, the delivery of parts may then take place. This principle is illustrated in FIG. 14. Here, the same process as in FIG. 13 is used as basis, which is not described again. In contrast to the scenario shown in FIG. 13, however, the repeat order 1320 or subsequent delivery is not directly determined by the installation time 1322. Rather, the re-ordering is determined by the production process platform 1330 on the basis of a time pre-calculation 1402 of the installation time 1322. In an extreme case, all parts required for the production process may be controlled as JIT/JIS parts and may thus be delivered as “preview parts” to the work stations.

Nowadays there is also no complete stock counting including the local stock at the location of need (line stock). Therefore, an optimization of the inventory in real-time throughout the entire logistics chain is also not possible with regard to the stock required in the future. The transports to the (assembly) line take place from the trailer station or supermarket where the parts are located. There are no “mixed” transports in which several trailer stations and supermarkets are approached one after the other such that a need-based supply-mix of material is composed. The required parts are delivered to invariably defined shelf compartments at the line. If the number of variants of a part (for example, colors of a decorative strip) exceeds the number of shelf compartments at the line, then the picking of the part takes place in an area preceding the line.

When the method according to the invention is used, there are clear advantages over the present situation. On the one hand, the supply of material may be carried out based on a forecast, controlled by consumption/need. The control of the supplies of parts is then carried out on the basis of exact future consumption. As a result, it is possible that only exactly that material is delivered to the line, which is needed there in a timeframe for the next x objects to be produced, e.g. vehicles. In the extreme case, where x=1, this corresponds to a JIS shopping cart delivery for the relevant work station. In addition, the transport may be controlled in such a way that mixed transports are possible.

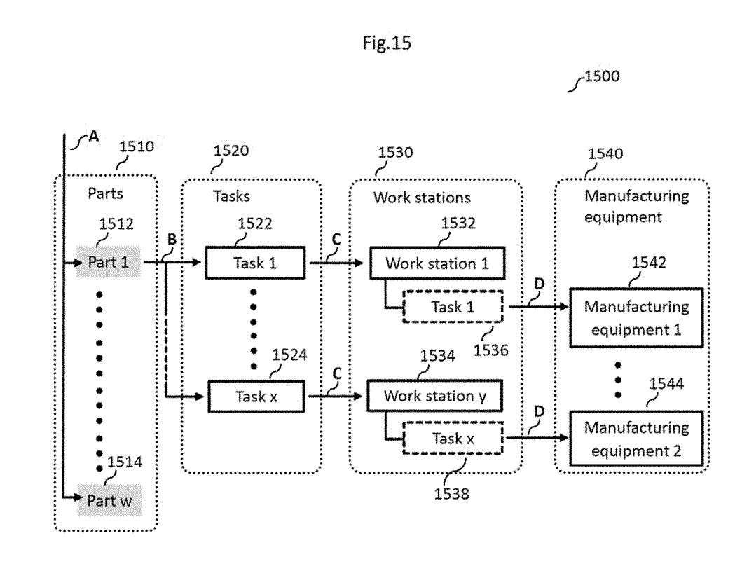

After having described the control of processes by the method according to the invention in numerous examples, in the following the planning and control process will be described in more detail below. In FIG. 15, a possible process sequence within the production process platform is illustrated. The illustrated process flow is just one of many possible embodiments of how a user may interact with the production process platform. The program interface of the production process platform can be set up in such a way as to enable the actions illustrated in FIG. 15.

The process flow 15 shown in FIG. 15 begins with the selection of a part from a group of parts 1510 which is used within the value-adding chain. For example, a first part 1512 and a w-th part 1514 are illustrated, wherein the number w of selectable parts may be correspondingly large depending on the complexity of the end product. The planning process may thus begin with a first selection A, in which the respective part is selected from the group 1510. In the present example, the scenario will be explained based on the first part 1512. The group 1510 may contain the total number of parts used or may also represent a subgroup, for example all parts required for the construction of a dashboard.

After selecting the part, tasks may be assigned thereto from a group of tasks 1520. In the present example, a first task 1522 and an x-th task 1524 are shown. The group of tasks 1520 may contain predefined tasks. Furthermore, the group of tasks 1520 may be limited to tasks which are usually performed with respect to the selected part. If the selected first part 1512 is a rear-view mirror, then the tasks which may be selected may be, for example, order picking, picking (i.e., gripping/taking out, for example, from a storage shelf), checking, installing. The assignment of tasks to 1520 to parts 1510 corresponds to a second selection B or a second assignment B. Of course more than one task may be assigned to each part.

By means of a third selection C, work stations 1530 may be assigned to tasks 1520, that is, locations in a manufacturing plant where the respective tasks are to be carried out. For example, it may be determined that the selected first task 1522 is to be performed with respect to the first part 1512 at a first work station 1532. For example, in the exemplary scenario, it is possible to determine at which work station at a production line a rearview mirror may be installed in a vehicle. Usually, exactly one work station is assigned to each instance of a task. However, a task may be subdivided into several steps such that each substep is assigned to a different work station. In the exemplary scenario, the rear-view mirror is reasonably mounted at one work station.

After the allocation of the tasks 1520 to work stations 1530, by means of a fourth selection D, finally manufacturing equipment 1540 may be assigned to the tasks 1530. In FIG. 15 it is shown that a first equipment 1542, e.g. a screwdriver, is assigned to the first task 1536, which has been assigned to the first work station in 1532 (hence the dotted framing indicating an already assigned task). At least one piece of manufacturing equipment from the group of manufacturing equipment 1540 may be assigned to each of the tasks from the group of tasks 1520.

Each selection A-D may be also seen as an allocation. A corresponding program-technical implementation may, for example, be realized via drop-down menus or by means of a “drag-and-drop” function. Each of the objects in the different groups 1510-1540 may have parameters which are adjustable and determine the potential scope of choices at a certain selection A-D. For example, for an x-th task 1538, which has been allocated to a y-th work station 1534, only equipment may be displayed which is actually available/usable at this work station or which is associated with the x-th activity 1538.

What makes the process sequence 1500 embedded in the production process platform according to various embodiments of the invention special is that processes of logistics and production may be planned directly side by side without any separation. In this way, the x-th task 1524, for example, may be one in logistics such as the delivery of the first part 1512 to a specific storage shelf (which would then be allocated as a corresponding manufacturing equipment). However, the x-th task 1524 may be one in production such as the already mentioned installation of a rearview mirror in a vehicle (wherein the screwdriver used for this task would be allocated as the associated piece of manufacturing equipment from the group of operating equipment 1540). Within the scope of the method according to the invention, the tasks and manufacturing equipment are handled in an abstract manner and, within the scope of planning, allocated to parts and distributed to work stations. It should be understood that the above-described selections A-D may be in a different order or may also link completely different groups of objects from the ones shown. For example, the parts from the group of parts 1510 may initially be assigned to work stations 1530, or the corresponding operating means 1540 may initially be assigned to the tasks 1520, and the activities 1520 may then subsequently be distributed to the work stations 1530.

After completion of the planning according to the described process sequence 1500, a simulation may be optionally carried out to check the planned operating state for consistency. The planned configuration may be transferred to the manufacturing equipment so that the production may proceed according to the plan. During the course of production, data from the production level may be transferred to the process production platform to keep the parameters of the objects in groups 1510-1540 up to date.

Within the scope of this description, there is also provided a computer program (i.e. an accumulation of instructions executable by a data processing device) for manufacturing a product, the computer program being configured to perform the method according to the invention upon execution on a data processing device which is coupled to respective production factors.

Also provided is a computer program product comprising executable program code, wherein the program code, when executed by a data processing device coupled to respective production factors, executes the method according to the invention. The computer program product may be any permanently or volatilely computer-readable instructions storing medium.

Furthermore, as is particularly apparent with reference to the accompanying figures, a data processing device is provided on which the computer program according to the invention is provided in an executable manner and which is coupled with respective production factors which are necessary for carrying out the method described herein.

1. A method for manufacturing a product, the product being a functional unit composed of at least two parts, each of which is located at a separate location, the method comprising:
at least one logistics process, in which a part is transported from its location to a location of use, and
at least one production process, in which the part is assembled with at least one further part at the location of use;
wherein the method is planned and/or simulated in a holistic manner before and during its execution in a first electronic data processing program and/or is directly controlled in a holistic manner by a second electronic data processing program, wherein the direct control takes place with regard to a group of production factors, which includes employees and/or operating resources and/or material.

2. The method of claim 1, wherein the first electronic data processing program and the second identical program are identical.

3. The method of claim 1, wherein the group of production factors also includes data.

4. The method of claim 1, wherein at least one instance in the first electronic data processing program and/or in the second electronic data processing program is allocated to each physical object which is involved in the method.

5. The method of claim 4, wherein the holistic direct control of the method is executed by the second electronic data processing program on the basis of process information which is transmitted from the physical objects to the instances in real time.

6. The method of claim 4, wherein each physical object which is involved in the method is assigned an address which is preferably based on the internet protocol.

7. The method of claim 6, wherein the holistic direct control of the method is executed by the second electronic data processing program on the basis of process information which is transmitted from the physical objects to the instances in real time.

8. The method of claim 6, wherein each physical object is associated with at least one instance via its address.

9. The method of claim 1, wherein the first electronic data processing program and/or the second electronic data processing program include a suitable programming interface for each physical object involved in the method.

10. A computer program for manufacturing a product, the computer program being configured to perform the method of claim 1 upon execution on a data processing device which is coupled to respective production factors.

11. A computer program product comprising executable program code, wherein the program code, when executed by a data processing device coupled to respective production factors, executes the method of claim 1.

12. A data processing device, on which the computer program according to claim 10 is provided in an executable manner and which is coupled with respective production factors.
